(19) United States
(12) Patent Application Publication
(10) Pub. No.: US 2025/0285134 A1
(43) Pub. Date: Sep. 11, 2025

(54) Computer implemented method for electronic cash registers

(71) Applicants: Adel Maganova, Milano (IT); Ravil Maganov, Dubai (AE); Vildan Khusainov, Verona (IT)

(72) Inventors: Adel Maganova, Milano (IT); Ravil Maganov, Dubai (AE); Vildan Khusainov, Verona (IT)

(21) Appl. No.: 18/601,055

(22) Filed: Mar. 11, 2024

(51) Int. Cl. G06Q 30/0207; G06Q 20/20; G06Q 20/40; G06Q 30/0238

(52) U.S. Cl. CPC G06Q 30/0224; G06Q 20/209; G06Q 20/4014; G06Q 30/0238

(57) ABSTRACT

A computer-readable medium storing a program including instructions that, when executed by an electronic cash register, may perform a method of rewarding a customer who is making a purchase at the electronic cash register at a point of sale of a merchant. The method may include computer implemented customer method for rewarding a customer making a purchase at an electronic cash register at a point of sale of a merchant, comprising the steps of:
the customer presents his Customer ID in the form of a QR code or electronic identification device;
a first module in the electronic cash register reads the Customer ID and send it to a remote server;
the electronic cash register authorizes a payment from a customer (20);
the electronic cash register generates a receipt for the payment;
an electronic cash register utility module executed in the electronic cash register extracts receipt data and send it to a remote server;
the remote server links the Customer ID with the receipt data and registers the linked data as a new transaction;
an analytical discount computation module determines an individual discount on future transaction, using an analytical response to discount amount curve,
wherein said response to discount amount curve is adapted to each customer using customer specific parameters retrieved by a machine learning module trained with previous transactions of said customer with said merchant and with other merchants.

### TECHNICAL FIELD

The present invention concerns the field of electronic cash registers and programs for such electronic cash registers.

### BACKGROUND

An Electronic Cash Register (ECR) serves as a crucial tool in the retail and hospitality industries, primarily at points of sale (POS), with the primary purpose of facilitating efficient and accurate financial transactions. It acts as a central hub for processing sales and handling payments, ensuring that businesses can manage their revenue and inventory effectively. More and more often, it can also execute other software modules, including modules for the handling of customers loyalty programs.

Typical hardware components of an ECR include a cash drawer to store currency and coins, a keyboard or touch screen for inputting transaction data, a barcode scanner for quick item entry, a receipt printer to produce cash receipts, and various connectivity options such as USB or Ethernet for linking to external systems or devices. Additionally, modern ECRs may integrate credit card readers or contactless payment terminals to accommodate a variety of payment methods.

The central function of an ECR is to record and calculate sales transactions. When a customer makes a purchase, the ECR records the item's price, calculates taxes, and generates a cash receipt as evidence of the transaction. A cash receipt is usually a printed document that provides a detailed summary of the purchase, including the items bought, their prices, any applicable taxes, the total amount paid, payment method, and change given. It serves as proof of purchase for both the customer and the merchant and is essential for accounting, tax reporting, and customer service purposes.

On the software side, an ECR typically runs an electronic cash register software that manages inventory, calculates taxes, tracks sales data, and generates cash receipts. This software may also include features like sales reporting, employee management, and customer relationship management. The software is crucial in automating and streamlining retail operations, enhancing efficiency, and reducing the risk of human errors in transaction processing. Other software modules and applications are often run in an ECR. The electronic cash register software and the other modules or applications are often run on an operating system such as Windows®, Android®, Unix® etc.

A printer driver of the operating system is used for printing cash receipts. It is a software component that enables communication between the ECR's software and the receipt printer hardware. The driver interprets the data from the ECR software, formats it appropriately, and sends it to the printer for physical output. It ensures that the cash receipts are printed accurately, with legible text, graphics, and any necessary barcodes. The printer driver is essential for maintaining the integrity of the transaction record and ensuring that customers receive clear and professional-looking receipts.

It is already known to reward customer after a purchase with a discount on future purchases. For example, loyalty programs have been proposed by retailers and by credit card companies, among others.

The rewarding programs proposed by credit card companies only work for purchases paid with a specific credit card. Purchases paid with other means, for example with a different card, with cash or with a smartphone are usually not rewarded. This system is thus only available for rewarding a limited portion of the purchases at a point of sale.

Loyalty cards are proposed by various merchants and retail chains. They usually only work with a specific merchant or chain, so that customers need to accumulate many different loyalty cards from different merchants or chains to benefit from the various programs. Many customers are not willing not affiliate to a large number of loyalty programs from different merchants. Moreover, small merchants don't have the technical infrastructure to set up such a loyalty program, nor the motivation to reward infrequent/casual customers.

The optimal amount of the discount on future purchases depends on a critical balance between incentivizing customer spending and maintaining the merchant's profit margins.

At small discount values, the motivation for customers to increase their spending may not be adequately stimulated, leading to a negligible impact on sales volume. Conversely, excessive discounting can erode merchant margins to the point of unprofitability, counterintuitively stagnating or reducing net revenue despite an uptick in sales quantity. In addition, the customer cannot spend more than his purchasing power allows him.

Moreover, the optimal amount of discount is individual for each customer and for each merchant. Discounts should be tailored based on the projected lifetime value of a customer, where customers receive discounts as an investment in future revenue. Large retail chains may have an in-depth knowledge of most of their customers and could offer individualized discounts on future discounts.

In summary, the computation of the ideal discount depends on many parameters related to the current and previous transactions involving the customer and the merchant. There is no widely available equation or analytical method available for computing this optimal amount.

It has already been suggested to train a self-learning system, such as a neural network, for determining the optimal amount of discount on future purchases to offer to each client. One could for example consider to train a self-learning system with individual replies to different incentives, and learn it to determine the optimal incentive or discount to offer in a given situation. Such a self-learning system would however be extremely complex and require a huge amount of processing power. Moreover, it would only be able to determine the right amount of discount when enough transactions are available to train a system. Smaller merchants or new merchants with a limited amount of transactions won't be able to train the system; in a similar way, non-recurring customers with a limited transaction history would be less known by the system and thus offered inadequate discounts.

Therefore, such a computation method based on artificial intelligence is only available if the merchant has enough data for training a machine learning based system, and thus not feasible for smaller merchants or less often recurring customers.

### SUMMARY

There is therefore a need for a method and system to determine the individual amount of discount on future purchases that should be offered to each customer following a transaction, wherein the method should also be available to small merchants who lack both the technological infrastructure required by prior art solutions and the required knowledge of their customers.

This optimization problem is not solely a business concern but is also technically challenging due to the need to acquire transaction data from a variety of different point-of-sale equipment, process data without revealing to a merchant purchases made at other merchants, and provide advanced methods that enable rapid computation and adaptation to individual customer purchasing behaviours.

An aim of the present invention is thus the provision of a method that fulfills those various requirements and overcomes the shortcomings and limitations of the state of the art.

It is also one aim of the invention to provide a system and method to determine the individual amount of discount on future purchases that should be offered to each customer following a transaction, wherein no merchant has access to information about transactions involving other merchants.

According to one aspect, those problems of the prior art are solved or at least mitigated by the object of the attached claims, and especially by giving to each merchant, especially the small ones, the benefits of a computation of a discount that depends not only on the knowledge of the customers transactions with that merchant, but also with other merchants.

According to some aspects, those problems are also solved or mitigated with a computer implemented customer rewarding method for rewarding a customer making a purchase at an electronic cash register at a point of sale of a merchant, comprising the steps of:
the customer presents a Customer ID in the form of a QR code or electronic identification device;
a first module in the electronic cash register reads the Customer ID and send it to a remote server;
the electronic cash register authorizes a payment from a customer;
the electronic cash register generates a receipt for the payment;
an electronic cash register utility module executed in the electronic cash register extracts receipt data and send it to a remote server;
the remote server links the Customer ID with the receipt data and registers the linked data as a new transaction;
an analytical discount computation module determines a customer dependant sigmoid response to discount amount curve, calibrated for the customer using machine learning on customer and/or merchant purchase history data;
an optimal discount that optimizes the additional profit (ΔP) is then determined.

The response to discount amount curve may be adapted to each customer using customer specific parameters retrieved by a machine learning module trained with previous transactions of said customer with said merchant and with other merchants.

The response to discount amount curve may be calibrated depending on the customer purchasing power (a^{max}) and/or customer susceptibility to incentive (α, β).

The optimal discount may depend on a customer specific probability of churn and a customer specific probability of using the reward.

The customer specific parameters are usually not known in advance and may be changing in time. They are determined with the machine learning module.

This method solves a number of technical problems.

The machine learning system is only required to determine specific parameters of the response to discount amount curve, such as a customer specific probability of churn and a customer specific probability of using the reward. It is not required to determine directly the optimal amount of discount. Determining single parameters, such as a probability of churn and a probability of using the reward, is an easier problem to solve for a machine learning system, meaning that is does not require high computational cost and time. The machine learning system usually is not required to be trained with a huge amount of transaction data, a large model, or a large training effort to be able to determine those parameters.

In fact, even a very limited amount of customer transaction data is sufficient for training a machine learning model so as to predict the probability of churn and the probability of using the reward. The probability of churn can be estimated even for an unknown or little-known customer.

For example, some merchants work mainly with repeat customers, while others, such as those who only have one single shop in a tourist or high-traffic area, have few repeat customers. In such cases, the probability of churn is not very customer-specific and can be assessed with a high degree of accuracy even for a new customer, and even if the merchant has recently joined the system.

Therefore, the method provides a reliable determination of the optimal discount event when only a small number of transactions for a given product at a small business retail outlet is available.

The claimed method thus replaces complex and difficult to train machine learning systems with simpler machine learning models which compute easier to obtain intermediate values (probability of churn and probability of using the reward) that can be used in a separate, analytical discount computation module.

The machine learning module thus provides parameters for an analytical computation performed by the discount computation module. The discount computation module could be a relatively easy to program analytical module.

Therefore, the method could be easily scalable and adapted even if the number of customers and the number of merchants grows up to several million. The model ensures minimization of computational costs when the number of retail outlets is scaling to several million and the volume of data for various product items is large.

The method also solves the problem of acquiring transaction data that are needed to train the machine learning model and for computing a discount after a specific transaction. The transaction data that are required to compute a future discount are retrieved from purchase receipts. Basically any ECR can generate and print or send purchase receipts. The method can thus be adapted to existing ECR devices without any need for replacing or adapting the existing software; one only needs to install an additional software module in the ECR that can collect pre-generated purchase receipts in digital form, and retrieve transaction data from those already existing purchase receipts. This ensures compatibility with virtually any existing ECR.

Furthermore, the link between the transaction data and the customer identity is made in a remote server, and not in the ECR. This remote server can be operated by a third party. In that case, the merchant does not learn which purchase has been made by which customer. This means that the customer only needs to trust one single third party, i.e., the operator of that remote server, instead of needing to trust all the merchants from which he makes a purchase. Moreover, the merchants do not learn what their customers purchased from other merchants, but might apply discount depending on the customer habits of their customers with those other merchants.

The step of extraction of receipt data can possibly include:
a print service prepares a print job file for a printer and sends said print job file to a printer driver;
the electronic cash register utility module reads the print job file;
the electronic cash register utility module interprets the content of the print job file and extract said receipt data.

The method may include the step of determining individually for each customer at least one point of an individual response to discount amount curve. This curve indicates, for each customer, the relation between a discount amount and the probability to be incentivized to make a new purchase.

The response to discount amount curve is typically a sigmoid. The amplitude and position of the midpoint of the sigmoid are determined based on the purchase history of each customer and characterizes the purchasing power and susceptibility to promotion.

At small discount values, the customer is not sufficiently incentivized to spend more, so the function grows more slowly in this range. In addition, the customer cannot spend more than a pre-determined purchasing power allows, which means that at large discount values the function stops growing. This curve is phenomenologically similar to the asymmetrical s-shaped curve of subjective value versus payoff in Kahneman's prospect theory. [D. Kahneman, A. Tversky. “Prospect Theory: An Analysis of Decision under Risk”. Econometrica. 47 (2), 263, (1979)]

The use of a sigmoid curve is an analytical method, relying on an analytical function. It is thus fast and requires only a limited amount of processing power. A standard curve can be applied for determining the discount to apply to new or less well known customers.

The response to discount amount curve can be customized to each customer. Preferably, this curve is calibrated with a machine learning system used for determining parameters of the response to discount amount curve.

The curve may also be merchant dependant. For example a merchant selling predominantly discounted goods or services may be associated with a different curve than a merchant selling predominantly premium goods or services.

The method may include a step of using a machine learning module for determining the point of the customer individual response to discount amount curve.

The machine learning module may receive at least one among the following input data:
information whether the customer is a new or recurring customer
product that was purchased
amount products purchased
payment method.

The method may include a step of adding a random part to a part individually determined for each customer. This random part has been demonstrated to be a strong incentive; customers are motivated more effectively if there is a possibility of receiving a multiple discount than usual.

The size of the random part may be probabilistic and regulated by taking into account proximity to the purchasing power limit and the likelihood of taking advantage of the offered discount. If the price of the discounted purchase, taking into account the random win, is still within the customer purchase limit (sigmoid plateau), then the probability of such a win increases, and otherwise decreases.

The probability of the random win may also depend on the customer's interest in the discount, which is measured by analyzing the customer's purchase history.

The machine learning module may further determine a customer's individual purchase limit, and the discount computation module may determine said individual discount on a future transaction based on said customer's individual purchase limit.

### BRIEF DESCRIPTION OF THE DRAWINGS

Exemplary embodiments of the invention are disclosed in the description and illustrated by the drawings in which:

FIG. 1 illustrates schematically a flowchart of the different steps and components involved during acquisition of the transaction and customer data;

FIG. 2 illustrates schematically a flowchart of the different steps and components involved during transaction registration;

FIG. 3 illustrates schematically a flowchart of the different steps and modules involved during computation of the IFD;

FIG. 4 is an example curve showing the typical dependence of customer response (amount of expense) as a function of the amount of discount;

FIG. 5 illustrates schematically a flowchart of the different steps involved during computation of the IFD;

FIG. 6 illustrates schematically the main principles and main components of a system used for determining the IFD . . .

### DETAILED DESCRIPTION

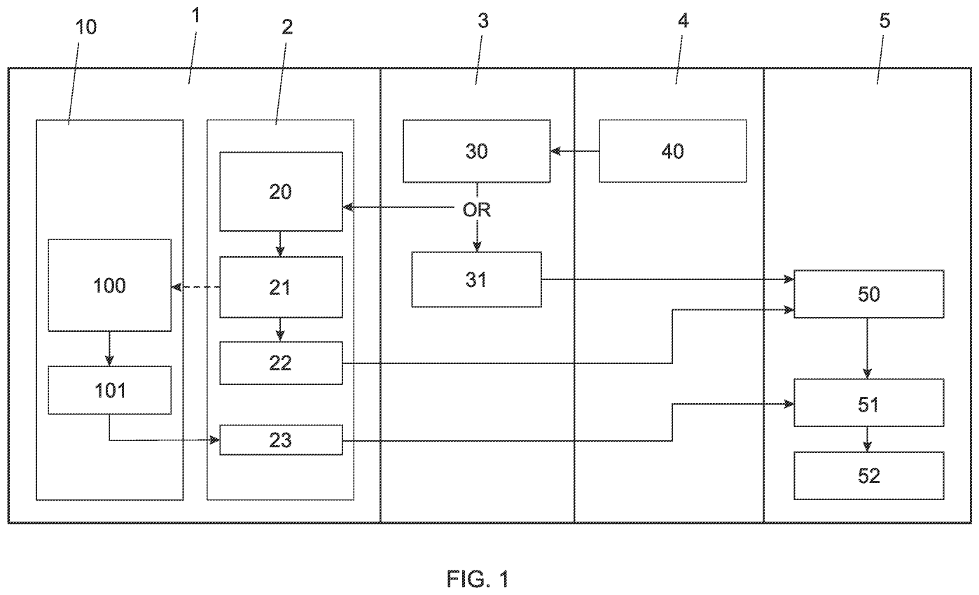

A possible method for obtaining the transaction and customer data is illustrated with reference to FIG. 1.

After or during a purchase, a customer 4 at a point-of-sale 1 presents a customer ID to the ECR device or to an operator 3 of the ECR device (step 40). The customer ID may be presented as a QR code, for example a QR code displayed on a smartphone screed, or as a beacon, such as an NFC or Bluetooth beacon.

The customer ID is read and registered in step 30 by an operator application 31 running in the ECR. This application 31 is independent of the ECR software 1 executed by the ECR to process the purchase. Independent here means that this application can be installed separately from the ECR software 1, and can work with different such ECR software, without directly interacting. In a preferred embodiment, the operator of the ECR 1 does not have access to the customer ID, and thus does not learn the identity of his customer. The application 31 then sends the customer ID to a remote server 5 which receives it in step 50).

Alternatively, a utility module 2 running in the ECR may activate a dialogue to prompt the customer 4 to present his customer ID (for example a QR code) during step 20. The operator then scans the QR code with a scanner (step 21), and the customer ID is simultaneously sent to the remote server 5 (step 20) which receives it during step 50.

The remote server 5 may be managed by a third party. A single remote server preferably processes customer IDs received from different ECRs and from different merchants.

The customer then makes a purchase at the point of sale. The collection and transmission of transaction data preferably involves following steps:
the electronic cash register authorises a payment (step 100);
the electronic cash register generates a receipt for the payment;
a print service prepares a job file for a printer and sends the job file to a printer driver which prints it (step 101). The print service may for example write the incoming print job to a file in the working directory. This file is available for a short time until the printer finishes printing, and then deleted.

The electronic cash register utility module running in the electronic cash register reads the job file before it is deleted;
the electronic cash register utility module interprets the contents of the job file and extracts the receipt data;
the electronic cash register utility module 2 sends the receipt data to the remote server 5 (step 23);
the remote server 5 receives the transaction data and links it to the received customer ID (step 51);
the remote server 5 registers the transaction (step 52).

This method has the advantage that the data corresponding to the cash receipt is collected from a job file, which can be generated by virtually any ECR software, in order to print the transaction receipt. The method thus provides a new method of interfacing with virtually any electronic cash register that can print a receipt via a print job file. The method can thus be easily used with an existing set of different electronic cash registers, without the need to replace or update any existing component of the existing electronic cash registers, and without the need to modify existing programs.

The embodiment thus relies on intercepting and interpreting print job files to retrieve the receipt data.

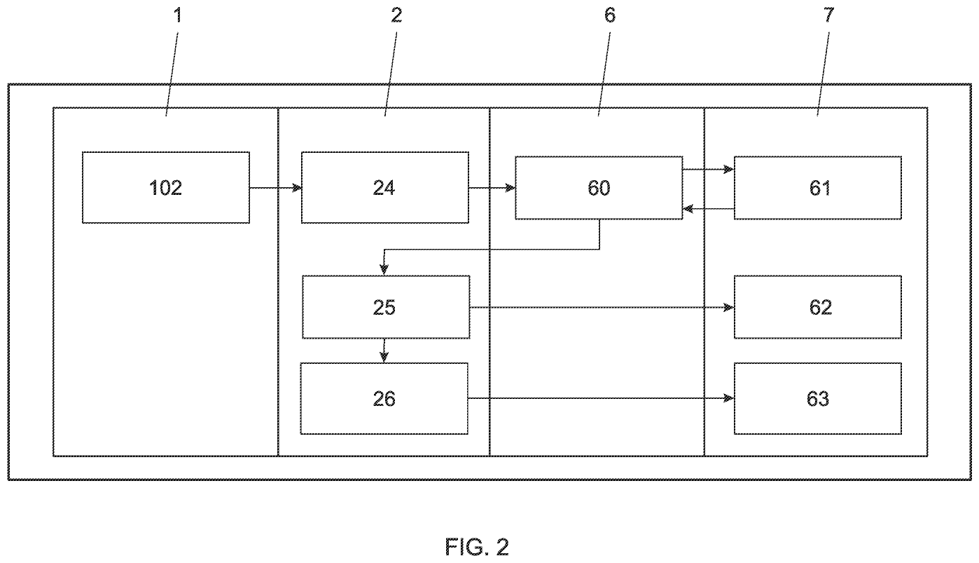

The registration of the transaction will now be described with reference to FIG. 2. This process takes place on the remote server 5. After the remote server receives the customer ID and transaction data and links the two components (step 52), it passes them to an API processing service 2 to calculate the discount on future purchase (IFD) and register the transaction. The API processing service contacts an AI service 6 and provides it with the transaction data and customer ID (step 24). The AI service 6 calculates the IFD (step 60) by accessing a customer transaction history 61 and other data stored in a database 7. As will be described later, the AI service 6 primarily uses an analytical module to determine the IFD from a customer specific response to discount amount curve, the curve being adapted to each customer using a machine learning module.

The AI service 6 then returns the value of the calculated and accumulated discount on future purchases to the processing service API 2. The processing service API registers the transaction (step 25), registers the IFD value (step 26). It then stores the new IFD value for the customer ID (step 62) and the IFD value (step 63) in the database 7.

Granting a discount on a future purchase (IFD) increases the likelihood of the next purchase for each customer. Thus, according to one aspect, an individual IFD is determined in the remote server individually for each customer and for each merchant.

We will now describe the process of calculating the IFD.

Preferably, a module in the remote server 5 determines whether the customer is a new customer or a returning customer. A machine learning module as part of the AI service 6 determines customer specific parameters, such as the probability of churn for the customer and/or the probability of using the reward and/or other customer specific parameters. These customer-specific parameters are determined using a machine learning system, such as a neural network, taking into account the customer's transaction history and purchase history with the merchant.

A discount amount computation module in the remote server 5 then uses these customer specific parameters to calculate an individual discount to increase the likelihood of the next purchase while generating additional profit for the merchant. This calculation is analytical and may use a response to discount amount curve parameterised for the customer.

The future purchase discount IFD preferably comprises two components:
a) a first component, called CLV term (customer Life Value)
b) and a random win component

The calculation of the first term (CLV term) is preferably based on an incentive response function that is individually adapted for each customer. This is a parametric function, determined by a parametric computation module using an AI module to determine some parameters of the curve.

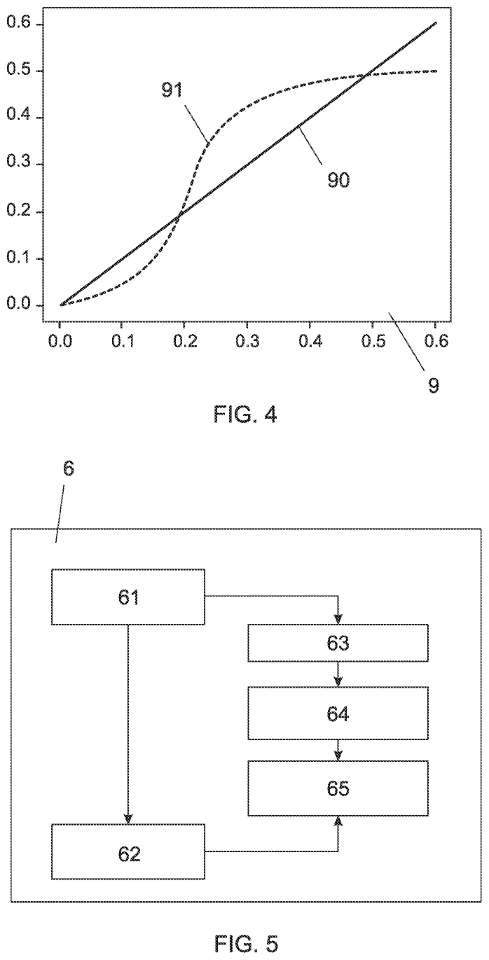

An example of incentive response function 91 is illustrated on FIG. 4. It is typically a sigmoid function and indicates, for each customer, the customer life value (response) as a function of the discount amount.

The customer life value (response) increases as the probability of that customer making a new purchase increases, and/or as the probability of higher margins with that customer increases. This customer life value decreases when the probability of churn increases, or when the granted discount erodes the merchant's margin. Thus, the fact that the next purchase must be made is taken into account, which means the function includes the probability of churn, which is calculated for each customer based on their purchase history.

For small discount values, the customer is not sufficiently incentivised to spend more, so the function grows more slowly in this range. In addition, the customer cannot spend more than his purchasing power allows, so the function stops growing at large discount values. This curve is phenomenologically similar to the asymmetric s-shaped curve of subjective value versus payoff in Kahneman's prospect theory. [D. Kahneman, A. Tversky. “Prospect Theory: An Analysis of Decision Under Risk”. Econometrica. 47 (2), 263, (1979)].

The parameters of each customer's individual curve are determined using a machine learning system based on each customer's purchase history, taking into account their purchasing power and susceptibility to a discount as an incentive. The discount value can then be determined from the curve by optimising the CLV increase in response to the proposed discount. The discount size is optimized for each product, for which its own margin value is set. This marginality is unlikely to change drastically if the frequency of purchases is high, i.e. if the time between the moment the IFD is calculated and future purchase is small; therefore, the determination of the IFD is based on the margin-value known at the time of IFD calculation.

The second component d^{rnd} of the IFD is a random win, and based on the observation that customers are motivated more effectively if there is a possibility of receiving a multiple discount than usual. The possibility that the IFD may be a multiple of the usual discount significantly motivates the customer to make a purchase.

The size of the random win is probabilistic and controlled by feedback: it takes into account proximity to the purchasing power limit and the likelihood of using the discount offered. If the customer has not reached his purchasing power limit (sigmoid plateau), the probability of the second term increases, otherwise it decreases. The probability of the second term also depends on the customer's interest in the discount, which is measured by analysing the customer's purchase history. The final size of the IFD is determined by further feedback on the weighted average discount. The weighted average discount for all customers should not exceed a given limit, thereby guaranteeing a profit for the seller.

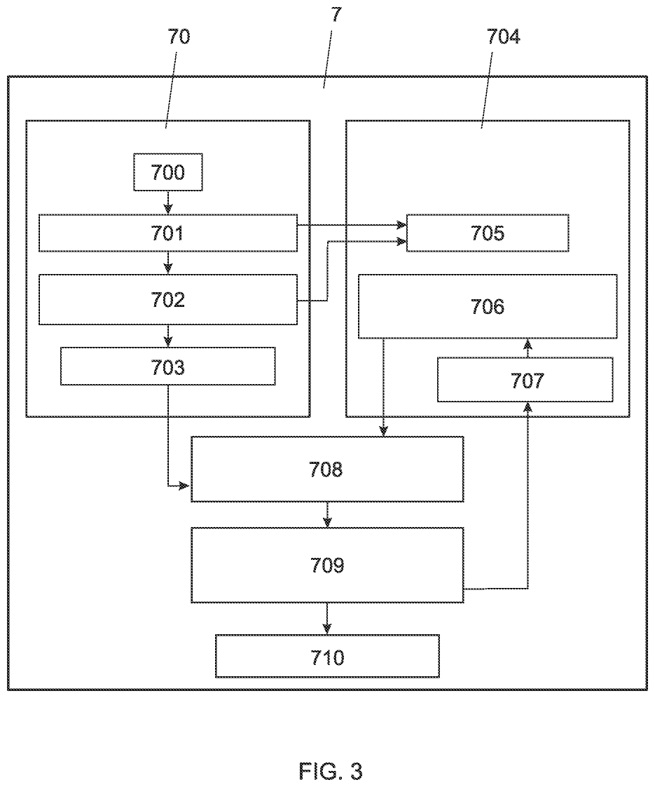

An example of workflow followed by the AI service 6 for computing the IFD will now be described in relation to FIG. 3. The IFD amount preferably comprises two components: a first CLV component, computed during steps 70, based on the customer specific response to discount curve, and a random component computed with steps 71.

At step 700, a customer-specific probability of churn is determined for the previously identified customer using a machine learning module trained on previous transactions. At optional step 701, a proximity of the customer to his purchasing power limit is estimated based on knowledge of the customer. In step 702, a customer-specific probability of using the discount is determined for the previously identified customer using a machine learning module trained on previous transactions.

In step 703, three parameters are used to calibrate the curve:
a^{max}—represents the customer purchasing power and defines magnitude of the curve;
α and β, which represent customer susceptibility to incentive and define steepness and shift of the curve.

The curve gives a hypothetical behaviour of a customer as a response to incentive under ideal conditions (zero churn and 100% of likelihood of using the discount offered). Still in step 703, the calibrated curve along with the customer specific parameters (churn, proximity of the customer to his purchasing power limit, possibly other parameters) are then used to construct an additional profit function ΔP which essentially represents the additional profit of the merchant. Solving an optimization problem with respect to discount amount varied gives an optimal analytical amount of discount d^{reg} and assures maximization of merchants additional profit ΔP.

At step 705, the previously determined proximity to the purchase limit, possibly with other customer specific parameters, is received by the module responsible for determining the random portion of the discount amount. At step 706, a random amount value within a customer specific individual range is determined depending on this proximity. This random part also depends on a feedback on the maximum discount received at step 707.

At step 708, the total discount is calculated as a sum of the analytical discount d^{reg} calculated in step 703 and the random value d^{rnd} determined in step 706. At step 709, a check is performed to see if this sum exceeds a threshold, e.g. a customer and/or merchant specific threshold set by the merchant and/or depending on the customer's purchase limit. Thus, the weighted average IFD value for a period will not exceed a specified limit.

The result of this check is fed back to step 707 and a new random component is determined if the sum of the under exceeds this limit. The IFD (discount on future amount) is then determined at step 710.

We will now describe, with reference to the functional diagram of FIG. 5, how the machine learning module in the AI service 6 determines the parameters of the customer's individual response to the discount amount.

The data relating to the new transaction registered in step 62 is stored in the transaction database 61 together with data relating to the previous transactions of the customer, based on the accumulated volume of unique purchase history data.

In step 64, the data relating to all transactions is periodically processed, for example to remove errors, calculate averages, etc. At step 65, the machine learning module is used to periodically determine customer-specific parameters, such as a probability of churn or a probability of using the reward.

In step 60, the AI server then determines the IFD.

The following transaction data could be used as input and/or for training the machine learning module.:
type of product,
price of product;
product amount,
discount amount for each product,
payment method.

The data can be retrieved from the purchase receipt and transmitted to the AI server.

As previously indicated, the IFD depends on the purchase history of the customer with the merchant, and possibly with other merchants. It may also depend on the transaction history of the merchant.

The data output by the machine learning module is used for the calibration of the customer specific response to discount amount curve, i.e, its adaptation to each customer. The data output by the machine learning module includes for example the probability of customer churn and/or the probability of using the incentive. It may also indicate the purchasing power or purchase limit of the Customer.

The mathematically formulated CLV function depends on a number of individual metrics, includes the margin of each product, which is updated dynamically, and the incentive size on which optimization is performed to determine the first term of the IFD. As already indicated, the CLV part of IFD is determined through optimization of an objective function (profit), which consist of a calibrated response to incentive curve, considering also the churn probability term and the amount of discount to be used.

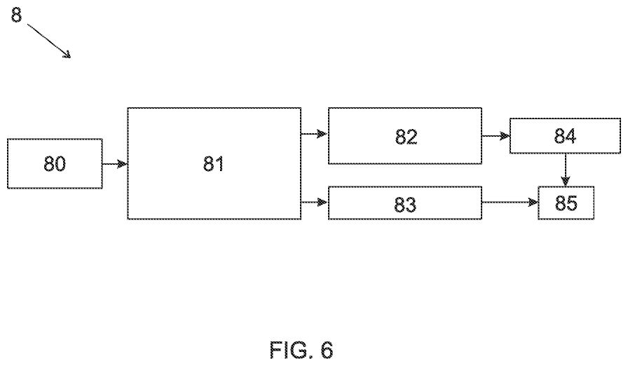

FIG. 6 is another flowchart illustrating various steps that could be used to calculate the IFD.

In step 80, the machine learning model determines customer-specific parameters of the response to rebate amount curve 91, as described above. At step 81, the analytical curve is calibrated for the customer using the previously determined parameters. The parameters could include, for example, purchasing power, customer-specific probability of churn, customer-specific probability of taking the reward, etc.

At step 83, the analytical part of the rebate is determined from this curve by selecting an optimal point on the curve, for example a point that gives a return close to the maximum of the sigmoid without requiring a large amount of rebate.

At step 82, a difference is determined between the maximum discount that can be granted and this analytical portion. This difference is used to determine the range of values that are acceptable for the random portion of the IFD. In step 84, the random part of the IFD is determined within this range using an appropriate distribution function. In step 85, the IFD is then determined as the sum of the analytical part determined in step 83 and the random part determined in step 84.

We will now describe an example of a mathematical function that could be used to calculate the IFD.

The input parameters could include one or more of the following values, received from the ECR or input by the merchant for example:
Account ID: for example 2356234.
IFD_Balance, i.e., accumulated by customer amount of individual future discount. For example $210.00.
TransactionTime: for example 2023 Jun. 22 13:13:05.00
Amount: total amount of transaction, for example $14.00
Discount_limit: for example 20%.
Product price: for example $7
Product EAN: for example 5901234123457.
Product Margin: for example 20%
Product Group: for example 7.
Product Quantity: for example 2
Product Cost: for example $7
IFD_writeOff: (limit for percentage of IFD usage) 20%-

For each transaction, the parameters output by the machine learning system include for example
Churn (churn probability of the customer). For example 0.57
Probability of using the reward.

In one embodiment, the churn and/or the probability of using the reward can also be calculated using at first Bayesian equation, and then be further actualized more realistic values with higher precision using machine learning. The use of Bayesian methods is effective for example when the amount of data available is limited so that relying on machine learning only may be less reliable.

For each transaction, the discount computation module determines from those parameters the IFD_amount: (calculated for each product in transaction): for example $1.00

The above indicated examples of values are illustrative only. The method is not restricted to those examples.

### Customer Revenue Value for the Period

The probability of making the next purchase has the form of a sigmoid as a function of the value of IFD, d, having the form

$$σ ( d ) = \frac{1}{1 - exp ( - α \frac{d - β}{m} )}$$

where the already mentioned parameters a and β characterize the customer's susceptibility to an incentive in the form of a discount.

Considering that with a zero incentive the probability will remain the same

$$Δ {a}_{i} ( d = 0 ) = 0$$

and with a maximumᵢ incentive the increase is limited by purchasing power

$$Δ {a}_{i} ( d = {d}_{max} ) = {a}^{max} - {\overline{a}}_{i} ,$$

the dependence on the magnitude of the incentive is expressed as follows:

$$Δ {a}_{i} ( d ) = ( {a}_{i}^{max} - {\overline{a}}_{i} ) \frac{σ ( d ) - σ ( 0 )}{σ ( ml ) - σ ( 0 )}$$

The CLV of each customer is the sum of the sequence of all their purchases, so for each purchase the probability that it will take place needs to be taken into account

$$R = {a}_{1} + ( 1 - {θ}_{1} ) [ {a}_{2} + ( 1 - {θ}_{2} ) [ {a}_{3} + … ] ]$$

where θᵢ is the probability of customer churn, which can be determined using Bayesian models and refined with a machine learning model.

The sigmoid is calibrated for the parameter a^{max}, which characterizes the purchasing power of the customer.

To calibrate the sigmoid response to incentives in the form of a discount, machine learning is used on purchase history data.

### Additional Profit Function for a Store at Equilibrium

The discount computation module could possibly also determine, for each merchant or shop:
Additional_Profit_ΔP
Additional_Profit_Potential

The additional profit could be determined using following parameters:
R_{I}^{new}—revenue from New customers in the 1st period
   R₂^{rep}—revenue from Repeat customers in the 2nd period following the 1^{st} period
   Cnr—conversion of new customers into repeat customers by revenue
   Crc—conversion of repeat customers into churn by revenue
k—change in conversions associated with IFD that increases the probability of a future purchase
   mᵢ—marginality of a product or group of products
   P=mR,ΔP-profit and additional profit
   D₁—total discount for all customers in the 1st period
   IFD-total discount on future purchase (issued)
   IFDₘₐₓ—maximum for total discount per POS for the period
   IPD-total applied discount on current purchases (used from IFD amount)
   d_{i,j}—the amount of individual discount on the j-th purchase of the -th buyer,

$$D = \overline{{\sum }_{i , j}} {d}_{i , j}$$

σ(d)—response sigmoid as a function of the discount size
Δaᵢ (d)—increase in purchase size due to the offered discount

$${QCLV}_{i} = {\sum }_{j} {a}_{j} ( {d}_{j} )$$

the customer's revenue as the sum of all purchases for the period
θᵢ-probability of churn during the i-th purchase
I—IPD value as a percentage of revenue

We can now determine the additional profit ΔP as a function of the IFD, of the cₙᵣ of the c_{rc} and of the margin m: ΔP (IFD, cₙᵣ, c_{rc}, m)

The total revenue during two periods is the sum of the revenues in the 1^{st} and 2nd periods, consisting of revenue from new customers and revenue from regular customers.

$${R}_{1} = {R}_{1}^{new} + {R}_{1}^{rep} ,$$

$${R}_{2} = {R}_{2}^{new} + {R}_{2}^{rep} -$$

The additional profit for a merchant is:

$$Δ P = ( {mR}_{2} - {D}_{2} ) - ( {mR}_{1} - {D}_{1} )$$

$${R}_{2}^{rep} = {c}_{nr} {R}_{1}^{new} + {R}_{1}^{rep} - {R}_{2}^{ch} , where {R}_{2}^{ch} = {c}_{rc} {R}_{1}^{rep} is the outflow of profit$$

$${R}_{2} = R {2}^{new} + {c}_{nr} R {1}^{new} + R {1}^{rep} - {c}_{rc} R {1}^{rep}$$

In the case of a POS at equilibrium, the increase in revenue from new customers is balanced by a decrease in revenue from the churn of customers.

Provided that the influx of revenue from new customers is constant R₁^{new}=R₂^{new} and supposing that in the first period D₁=0, D₂=IFD we obtain a simplified formula

$$Δ P = {mR}_{1}^{new} {c}_{nr} ( 1 + k ) - {mR}_{1}^{rep} {c}_{rc} ( 1 - k ) - {D}_{2}$$

In the equilibrium state, an additional condition

$${c}_{nr} {R}_{1}^{new} - {c}_{rc} {R}_{1}^{rep} = 0$$

then the additional profit is

$$Δ {P}_{s} = 2 m {c}_{rc} k {R}_{1}^{rep} - IFD$$

If the limit is set to IPD-I, then the additional profit ΔP from merchandise will be
IPD k m/l,
   where k is the change in conversions associated with IFD, which increases the probability of a future purchase

$$Δ {P}_{s} = {2 m}_{1} {c}_{rc} k {R}^{rep} - IPD + IPD k m / l$$

$$Δ {P}_{s} = {2 m}_{1} {c}_{rc} k {R}^{rep} + IPD ( k m / l - 1 )$$

This last function in the equation will have a positive value provided that k m/l>1 or

$$IPD < {2 k}_{1} {mc}_{rc} {R}^{rep} / ( 1 - k m / l )$$

The amount of applied IFD is equal to:

$$IPD = IFD ( 1 - {c}_{r c} + k )$$

$$Δ {P}_{s} = {2 m}_{1} {c}_{r c} k {R}^{rep} + IFD ( 1 - {c}_{rc} + k ) ( k m / l - 1 )$$

Having a control over IFD it is possible to set

$${IFD}_{max} = {k}_{1} {mc}_{rc} {R}^{rep} .$$

By controlling the value of IFD below IFDₘₐₓ through the feedback functions (described in the IFD section), the value of the additional profit is controlled.

Substituting the value of IFDmax instead of IFD, we get:

$$Δ {P}_{s} = 2 m {c}_{rc} k {{R}^{r e p}}_{1} + k {mc}_{rc} {{R}^{rep}}_{1} ( 1 - {c}_{r c} + k ) ( k m / l - 1 )$$

The reporting period is for example equal to a quarter. For most consumer goods, this is a sufficient period to determine the statistics of Regular Customers and Churn. Other periods, such as one month or one year, could be considered.

The amount of Additional Profit ΔP will always have a positive value provided that

$$1$$

$$k m / l > 1 or$$

$$IPD < 2 k {mc}_{rc} {R}^{rep} / ( 1 - k m / l )$$

The Additional Profit could be computed with analytical means. The amount of Additional Profit is proportional to the conversion rate of Regular Customers to Churn and the flow of regular customers who received IFD.

From the equation IPD=IFD(1-c_{rc}+k), by determining the actual values of IFD and IPD for the reporting period, the value of k can be calculated. The actual and potential additional profit can then be calculated by substituting the value of k into the above equations.

### IFD Feedback Functions

As previously explained, the discount includes two components:

$$d = {d}^{reg} + {d}^{rnd}$$

The regular part (analytically determined from the curve) takes values in the range:

$$0 \leq {d}^{reg} \leq m \cdot {b}_{lim}$$

In this non limitative example, the default value bₗᵢₘ=0.4, that is, the maximum size of the regular part is 40% of the margin.

Limiting the total discount to dₘₐₓ, we get the range for the random discount component d^{rnd}ₘₐₓ=dₘₐₓ−d^{reg}, where d^{rnd}ₘₐₓ, is the maximum possible value of the random discount set by the merchant for a given value of the regular part of the discount d^{reg}.

The random discount component accepts values from 0 to d^{rnd}ₘₐₓ. A feedback functions could be used for calculating it.

In one embodiment, the random discount component is randomly determined with a uniform distribution from 0 to d^{rnd}ₘₐₓ.

In another embodiment, the probability density distribution function decreases with the purchase amount, i.e., the probability of getting the maximum amount of random discount decreases when the amount of purchase increases to the point that the customer approaches his purchasing power, so that the incentive becomes less effective.

In yet another embodiment, the probability density distribution function depends on the difference between the accumulated IFD and the limit IFDₘₐₓ. Consequently, if the accumulated discount is null, then all random discount values are equally probable. If the discount limit is reached, then the probability of getting the maximum random discount is minimal, or null.

In yet another embodiment, the probability density distribution function depends on the proximity to the limit of purchasing power of the consumer. Consequently, if the purchasing power reaches a plateau, the likelihood of large discounts decreases compared to the likelihood of small discounts.

Those distribution functions could be combined. For example, the aggregated parameter influencing the probability of distribution of the discount amount could be expressed as a superposition

$${p}_{0} = ( {p}_{1} + {p}_{2} + {p}_{3} ) / 3$$

where 0<p₀≤1.

If p₀=1, then we have an equal probability of receiving a discount from 0% to d^{rnd}ₘₐₓ. As the value of p₀ approaches zero, the probability of receiving a larger discount percentage decreases.

The probability density for the random win discount size values d_{rnd} is expressed through the aggregated parameter of all three feedbacks.

After or during a purchase, a customer 4 at a point-of-sale 1 presents his customer ID to the ECR device or to an operator 3 of the ECR device (step 40). The Customer ID may be presented as a QR code, for example a QR code displayed on the display of a smartphone, or as a beacon, for example an NFC or Bluetooth beacon.

The customer ID is read and registered at step 30 through an application 31 for operators run in the ECR. This application 31 is independent from the ECR software 1 executed by the ECR for processing the purchase. Independent means here that this application can be installed separately from the ECR software 1, and can work with different such ECR software, without interacting directly. In a preferred embodiment, the operator of the ECR 1 has no access to the Customer ID, and thus does not learn the identity of his customer. The application 31 then send the customer ID to a remote server 5 which receives it during step 50).

Alternatively, a utility module 2 run in the ECR may activate a dialog for prompting the customer 4 to present his customer ID (for example a QR code) during step 20. The operator then scans the QR code with a scanner (step 21) send it to the remote server 5 (step 20) which receives it during step 50.

1. A computer-readable medium storing a program including instructions that, when executed by an electronic cash register, perform a method of rewarding a customer who is making a purchase at the electronic cash register at a point of sale of a merchant, wherein the method comprises:
presenting a Customer ID;
reading the Customer ID, by a electronic cash register utility module in the electronic cash register, and sending the Customer ID to a remote server;
authorizing a payment from a customer;
generating a receipt for the payment;
extracting receipt data, by the electronic cash register utility module, and sending it to a remote server;
linking the Customer ID with the receipt data and registering the linked data as a new transaction;
generating a customer dependant sigmoid response to discount amount curve, by a machine learning module, based on customer and/or merchant purchase history data; and
generating an optimal discount that optimizes the additional profit based on the customer dependent sigmoid response to discount amount curve.

2. The method of claim 1, wherein the customer dependent sigmoid response to discount amount curve is determined for each customer using customer specific parameters retrieved by a machine learning module trained with previous transactions of said customer with said merchant and with other merchants.

3. The method of claim 2, wherein the customer dependent sigmoid response to discount amount curve is determined based on the customer purchasing power and/or customer susceptibility to incentive.

4. The method of claim 1, wherein the optimal discount is determined based on the customer specific probability of churn and a customer specific probability of using the reward.

5. The method of claim 4, further comprising constructing a profit function based on a customer specific probability of churn and a customer specific probability of using the reward.

6. The method of claim 1, wherein the extracting of receipt data comprises:
preparing a print job file for a printer and sending said print job file to a printer driver;
reading the print job file;
interpreting the content of the print job file; and extracting said receipt data.

7. The method of claim 1, wherein the optimal discount is determined by adding a random part to the optimal discount individually determined for each customer.

8. The method of claim 7, further comprising:
determining a maximum discount to be applied, and
capping said optimal discount when the addition of said random part to said individual part exceeds said maximum discount.

9. The method of claim 1, wherein the machine learning module is configured to receive one or more of the following:
data pertaining to whether the customer is a new or recurring customer;
data pertaining to product that was purchased;
data pertaining to amount of products purchased; or
data pertaining to a payment method.

10. The method of claim 1, further comprising:
determining, by the machine learning module, a customer's individual purchase limit; and
determining, by a discount computation module, a future discount for a future transaction based on said customer's individual purchase limit.

11. An electronic cash register comprising the computer-readable medium of claim 1.
